(19) United States
(12) Patent Application Publication
(10) Pub. No.: US 2016/0376800 A1
(43) Pub. Date: Dec. 29, 2016

(54) NON-INFLATION MASSAGING POOL

(71) Applicant: Shanghai Jilong Plastic Products Co., Ltd., Shanghai (CN)

(72) Inventors: Zhongxiu ZHANG, Shanghai (CN); Xuming TAI, Shanghai (CN); Jiankang XU, Shanghai (CN)

(21) Appl. No.: 15/039,737

(22) PCT Filed: Dec. 3, 2014
(86) PCT No.: PCT/CN2014/092914

§ 371 Date: May 26, 2016

(30) Foreign Application Priority Data
Dec. 3, 2013 (CN) 201310643302.6

(51) Int. Cl. E04H 4/00; A61H 33/00

(52) U.S. Cl. CPC E04H 4/0056; A61H 33/0087; A61H 33/6005; E04H 2004/0068; A61H 2201/0107; A61H 2201/0161; A61H 2201/0188

(57) ABSTRACT

A non-inflation massaging pool comprises a pool bottom and a pool wall connected to the periphery of the pool bottom. The pool sidewall is of a two-layered structure and comprises an inner wall and an outer wall, and interior space is formed between the inner wall and the outer wall, and the interior space is filled with a pool frame. The pool is durable and easy for installation and transport.

### FIELD OF THE INVENTION

This invention relates to an apparatus of a massaging pool, particularly to a portable and quickly-assembled massaging pool.

### BACKGROUND

A portable non-inflation pool is disclosed in Chinese Patent No. CN 2861383Y on 2007 Jan. 24, in which the pool body adopts an inflatable structure combined with a rigid structure. The inflatable structure is an inflatable chamber while the rigid structure comprises one or more rigid portions, and such rigid portion is filled within the inflatable chamber.

Existing portable massaging pools are divided into two types. The first type is inflatable. However, inflatable massaging pools have several disadvantages: (1) They are subject to heat and water pressure after containing water for a long time, and thus are vulnerable to expansion and deformation. The appearance and lifespan of the massaging pool may be adversely affected. (2) The deformed pool may impact the functionality of the massaging motors. (3) The pool is prone to leaking air. (4) The assembly process is complex.

Another type as disclosed in Chinese patent No. CN 2861383Y involves a detachable massaging pool. Such detachable massaging pool has the following disadvantages: (1) The error margin for the pool product is stringent. (2) It is relatively heavy and thus imposes difficulties in transporting and assembling the pool. (3) It is less cozy. (4) The liner may be deformed to some extent.

### SUMMARY

In view of the deficiencies for the portable type and detachable type massaging pools, according to embodiments of the present invention, it is desirable to provide a non-inflation massaging pool. The non-inflation massaging pool shares the advantages of the existing inflatable massaging pool, such as portability, as well as those of the acrylic-type pool, such as durability. In the meantime, the proposed non-inflation massaging pool eliminates the problems of the inflatable type pool, such as short lifespan and deformation, and the issues of the rigid-type pool, such as bulkiness and difficulty for transport and installation.

According to an embodiment, a non-inflation massaging pool is provided, which comprises a bottom and a sidewall attached to a peripheral of the bottom, characterized in that the sidewall is a two-layered structure, and includes an inner wall and an outer wall. Also, a space is formed between the inner wall and the outer wall, and a pool frame is disposed in the space.

According to an embodiment of the non-inflation massaging pool, the bottom is a two-layered structure, and includes an inner side and an outer side. A periphery of the inner side is attached to the inner wall. The outer side is optionally attached or not attached to the outer wall.

According to an embodiment of the non-inflation massaging pool, the bottom and the sidewall comprise a flexible composite enhanced material. The flexible composite enhanced material is selected from a mesh, artificial leather or composite material.

According to an embodiment of the non-inflation massaging pool, the inner wall and the outer wall are connected through a zipper, clasp, button, or string and wrap around the pool frame.

According to an embodiment of the non-inflation massaging pool, the pool frame is assembled with a rigid foam material. The rigid foam material is a liner formed by a blow molding process or comprises at least one of polystyrene (PS), polyethylene (PE), polyethylene terephthalate (PET), polypropylene (PP), ethylene vinyl acetate (EVA) and styrene-butadiene rubber (SBR).

According to an embodiment of the non-inflation massaging pool, the massaging pool is in a circular, oval or polygonal shape.

According to an embodiment of the non-inflation massaging pool, air passages are disposed on the inner wall, and several apertures are disposed on the air passages. The motor introduces air into the massaging pool through the air passages and the apertures on the air passages.

As compared to existing methods, the present invention provides a two-layered flexible composite enhanced material in the construction of a pool architecture. Then, within an interior space formed by the two-layered flexible composite enhanced material, the pool frame is assembled with several pieces of a rigid foam material. The rigid foam material provides a means to fix the shape of the flexible composite enhanced material. Upon injection of water, the pool is made more stable than before water is injected by taking advantage of the weight and tension of the water. In the meantime, the feature of less extendibility for the flexible composite enhanced material is used to mitigate the shortcomings of the PVC-type massaging pool, such as deformability, processing difficulty and inferior durability. Moreover, the defects of the rigid-type massaging pool are also addressed, such as discomfort, ineffective thermal insulation, bulkiness and difficulty for transport and installation.

Due to process limitations, the inflatable massaging pool is configured such that the vent exit is disposed near the bottom of the pool. Comparatively, the present invention adopts a frame formed of a rigid foam material that allows more vent exits at the inner wall of the pool by adapting to the locations where the user may lean on. Such arrangements can improve the massaging functionality or facilitate the placement of light bars. As a consequence, the proposed pool can incorporate more functions and greater quality than the inflatable massaging pool.

### BRIEF DESCRIPTION OF THE DRAWINGS

The accompanying drawings, which are incorporated in and constitute a part of this specification, illustrate embodiments of the disclosure and, together with the description, serve to explain the principles of the invention.

The foregoing summary, as well as the following detailed description of the invention, will be better understood when read in conjunction with the appended drawings. For the purpose of illustrating the invention, there are shown in the drawings examples which are presently preferred. It should be understood, however, that the invention is not limited to the precise arrangements and instrumentalities shown.

A more complete understanding of the present disclosure may be derived by referring to the detailed description and claims when considered in connection with the Figures, where like reference numbers refer to similar elements throughout the Figures.

FIG. 1 is a schematic diagram of a non-inflation massaging pool in accordance with embodiments of the present disclosure.

FIG. 2 is an exploded view of a non-inflation massaging pool in accordance with embodiments of the present disclosure.

FIG. 3 is a vertical sectional view of a non-inflation massaging pool in accordance with a first embodiment of the present disclosure.

FIG. 4 is a vertical sectional view of a non-inflation massaging pool in accordance with a second embodiment of the present disclosure.

FIG. 5 is a vertical sectional view of a non-inflation massaging pool in accordance with a third embodiment of the present disclosure.

The numerals in the Figures are shown where 3 denotes an air passage; 5 denotes a massaging pool containing water; 6 denotes a pool frame; 10 denotes a pool bottom; 11 denotes an outer side; 12 denotes an inner side; 21 denotes an inner wall; 22 denotes an outer wall; 30 denotes a connection portion; 40 denotes apertures; 50 denotes an interior space; and 100 denotes a massaging pool.

### DETAILED DESCRIPTION

In order to make the present disclosure completely comprehensible, detailed steps and structures are provided in the following description. Obviously, implementation of the present disclosure does not limit special details known by persons skilled in the art. In addition, known structures and steps are not described in details, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed embodiments, and is defined by the claims. The following description of the disclosure accompanies drawings, which are incorporated in and constitute a part of this specification, and illustrate embodiments of the disclosure, but the disclosure is not limited to the embodiments. In addition, the following embodiments can be properly integrated to complete another embodiment. References to “one embodiment,” “an embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The accompanying drawings and the following specific examples further illustrate the present invention. It is understood that embodiments of the present invention is for illustration only and not intended to limit the scope of the invention. After reading the contents according to the present invention, those skilled in the art of the present invention can make various changes or modifications, and such equivalents and modifications fall within the scopes of the claimed invention.

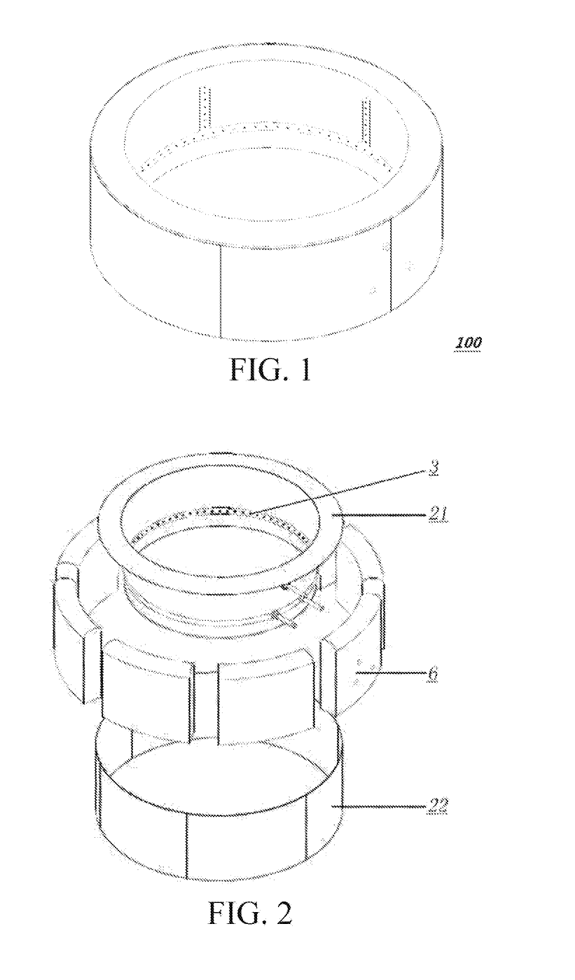

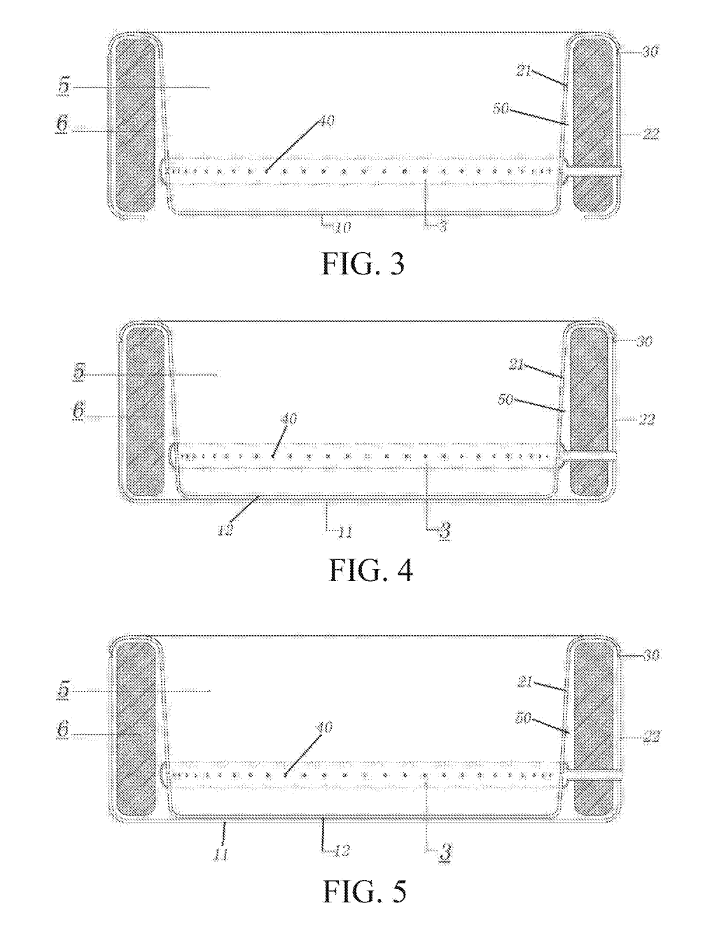

As illustrated in FIGS. 1-3, a first embodiment of the present invention provides a non-inflation massaging pool 100, which includes a pool bottom 10, and a pool sidewall attached to a periphery of the pool bottom 10. The pool sidewall is a two-layered structure, and comprises an inner wall 21 and an outer wall 22. An interior space 50 is formed between the inner wall 21 and outer wall 22, and the interior space 50 is filled with a pool frame 6. The pool frame 6 pool is made of a rigid foam material (in the present embodiment, the pool frame 6 is assembled vertically with the rigid foam material). The rigid foam material is selected from at least one of polystyrene (PS), polyethylene (PE), polyethylene terephthalate (PET), polypropylene (PP), ethylene vinyl acetate (EVA) and styrene-butadiene rubber (SBR). In the present embodiment, the pool bottom 10 and the pool sidewall (including the inner wall 21 and the outer wall 22) comprise a flexible composite enhanced material. The flexible composite enhanced material is selected from a mesh, artificial leather or composite material. In addition, as shown in FIGS. 2-3, the inner wall 21 and the outer wall 22 are connected at connection portions 30 through a zipper, clasp, button, or string and wrap around the pool frame 6.

Referring to FIG. 1, in the present embodiment, the massaging pool 100 is in a circular shape. However, the massaging pool 100 can also be in an oval or polygonal shape.

Referring to FIGS. 2-3, in the present embodiment, a ring (alternatively, multi-ring or multi-segment passages are also possible) of interconnected air passages 3 (alternatively, light bars or a combination of air passages and light bars are also possible) is disposed on the inner wall 21. The air passages 3 comprise a plurality of apertures 40 disposed thereon, and a massage motor is configured to introduce air into the water containing massaging pool 5 through the air passages 3. The air is released into the water through the apertures 40, therefore forming massaging bubbles.

The present embodiment utilizes a two-layered flexible composite material in the construction of the pool architecture. Then, the pool frame 6 is assembled by the two-layered flexible composite enhanced material that is in several pieces of a rigid foam material. The rigid foam material provides a means to fix the shape of the flexible composite enhanced material. Upon injection of water, the pool is made more stable than before water is injected by taking advantage of the weight and tension of the water. In the meantime, the feature of less extendibility for the flexible composite material is used to significantly decrease the deformation amount of the massaging pool upon subjecting to the pressure. Moreover, due to the detachable structure of the foam material pieces, the pool is light and can be assembled quickly.

Referring to FIGS. 1 and 4, a second embodiment of the present invention is provided, where the pool bottom is also a two-layered structure. The pool bottom includes an inner side 12 and an outer side 11. The inner side 12 is attached to the inner wall 21 at a periphery of the inner side 12 and the outer side 11 is attached to the outer wall 22 at a periphery of the outer side 11. In the present embodiment, the pool frame 6 is also vertically assembled with the rigid foam material. The remaining structure is similar to that illustrated and described for the first embodiment.

Referring to FIGS. 1 and 5, a third embodiment of the present invention provides a non-inflation massaging pool. The pool frame 6 is laterally assembled with the rigid foam material. The remaining structure is similar to that illustrated and described for the second embodiment.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A pool, comprising:
a bottom; and
a sidewall attached to a peripheral of the bottom, the sidewall being a two-layered structure, and including an inner wall and an outer wall,
wherein a space is between the inner wall and the outer wall, and a pool frame is in the space.

2. The pool of claim 1, wherein the bottom is a two-layered structure and includes an inner side and an outer side, the inner side being attached to a peripheral of the inner wall and the outer side being attached to the outer wall.

3. The pool of claim 1, wherein the bottom and the sidewall comprise a flexible composite material.

4. The pool of claim 3, wherein the flexible composite material is a mesh, artificial leather or composite material.

5. The pool of claim 1, wherein the inner wall and the outer wall are connected through a zipper, clasp, button, or string and wrap around the pool frame.

6. The pool of claim 1, wherein the pool frame is assembled with a rigid foam material.

7. The pool of claim 6, wherein the rigid foam material is selected from at least one of polystyrene (PS), polyethylene (PE), polyethylene terephthalate (PET), polypropylene(PP), ethylene vinyl acetate (EVA) and styrene-butadiene rubber (SBR).

8. The pool of claim 1, wherein the massaging pool is in a circular, oval or polygonal shape.

9. The pool of claim 6, wherein the pool frame is laterally assembled with the rigid foam material.

10. The pool of claim 6, wherein the pool frame is vertically assembled with the rigid foam material.
